(19) United States
(12) Patent Application Publication
(10) Pub. No.: US 2023/0134532 A1
(43) Pub. Date: May 4, 2023

(54) ALUMINUM ALLOY BARE MATERIAL FOR MEMBER TO BE BRAZED AND ALUMINUM ALLOY CLAD MATERIAL FOR MEMBER TO BE BRAZED

(71) Applicant: UACJ Corporation, Tokyo (JP)

(72) Inventors: Tomoki Yamayoshi, Tokyo (JP); Shinichi Nakamura, Tokyo (JP); Taichi Suzuki, Tokyo (JP); Hirokazu Tanaka, Tokyo (JP); Shogo Yamada, Kariya-shi (JP); Taro Fukuda, Kariya-shi (JP); Yosuke Uchida, Kariya-shi (JP); Nobuhiro Honma, Kariya-shi (JP)

(73) Assignee: UACJ Corporation, Tokyo (JP)

(21) Appl. No.: 17/913,489

(22) PCT Filed: Mar. 25, 2021
(86) PCT No.: PCT/JP2021/012630

§ 371 Date: Sep. 22, 2022

(30) Foreign Application Priority Data
Mar. 26, 2020 (JP) 2020-056450

(51) Int. Cl. B23K 35/02; C22C 21/10; C22C 21/08; C22C 21/02; B23K 35/28

(52) U.S. Cl. CPC B23K 35/0233; C22C 21/10; C22C 21/08; C22C 21/02; B23K 35/286; B23K 35/288; B23K 35/0238; B23K 2103/10

(57) ABSTRACT

An aluminum alloy bare material for a member to be brazed by flux-free brazing to a brazing sheet including a brazing material formed of an aluminum alloy that includes 3.00 to 13.00 mass % of Si and 0.10 to 2.00 mass % of Mg with the balance being Al and inevitable impurities, in which the aluminum alloy bare material for the member to be brazed is formed of an aluminum alloy including 0.004 to 6.00 mass % of Zn and 0.004 to 3.00 mass % of Mg with the balance being Al and inevitable impurities. According to the present invention, aluminum alloy materials can be provided for members to be well brazed to the brazing sheet with the brazing material including Mg when an aluminum material is brazed by flux-free brazing.

### TECHNICAL FIELD

This invention relates to a bare material and a clad material each of which is made of an aluminum alloy and used for a member to be brazed by flux-free brazing to an aluminum material.

### BACKGROUND ART

Brazing joint is widely used as a joining method for products with many small joints, such as aluminum heat exchangers and mechanical parts. To perform brazing joint of aluminum materials (including aluminum alloy materials), it is essential to break the oxide film covering the surface and bring the melted brazing material into contact with the base metal or the brazing material that has also melted. There are two main methods for breaking down the oxide film on aluminum materials: using flux and heating in a vacuum, both of which have been put into practical use.

Brazing joint has been applied to a wide range of fields. The most typical example manufactured by brazing joint is an automotive heat exchanger. Most automotive heat exchangers such as radiators, heaters, condensers, and evaporators are made of aluminum, and most of them are manufactured by brazing joint. Of these methods, the majority are now applied with noncorrosive flux and heated in nitrogen gas.

However, the flux brazing method increases the cost of manufacturing heat exchangers due to high costs of flux and the flux application process. Although there are methods of manufacturing heat exchangers by vacuum brazing, there is a growing need for flux-free brazing joint in a nitrogen gas furnace because of high costs for equipment and maintenance for the heating furnace as well as problems in productivity and brazing stability in the vacuum brazing method.

To meet this need, Patent Literature 1 proposes that Mg can be included in the brazing material to enable surface junction. In addition, Patent Literature 2 proposes a method in which Mg is contained in the core material and diffused into the brazing material during braze-heating, to prevent oxide film from being formed on the brazing material surface during clad material production and braze-heating while Mg effectively acts to break down the oxide film on the brazing material surface.

### CITATION LIST

### Patent Literature

Patent Literature 1: Japanese Patent Publication 2013-215797-A
Patent document 2: Japanese Patent Publication 2004-358519-A

### SUMMARY OF INVENTION

### Technical Problem

However, in the method of including Mg in the brazing material or the method involving Mg that is added to the core material and diffused into the brazing material, it is sufficient to break the oxide film of the brazing material during the braze heating, but it is not sufficient to break the oxide film of the member to be brazed. Therefore, good brazeability cannot be assured to joint the brazing sheet having the brazing material at its surface with the member not having the brazing material to be brazed.

Therefore, the object of the present invention is to provide an aluminum alloy material for a member to be well brazed to the brazing sheet with the brazing material including Mg when aluminum materials are brazed by flux-free brazing. The present invention also aims to provide a method of producing a brazed body in which excellent brazeability is achieved by breaking the oxide film on the brazing material surface including Mg of the brazing sheet while breaking the oxide film on the member surface to be brazed when the aluminum material is brazed by flux-free brazing.

### Solution to Problem

The above problems are solved by the following invention.

That is, the present invention (1) aims to provide an aluminum alloy bare material for a member to be brazed by flux-free brazing to a brazing sheet including a brazing material formed of an aluminum alloy that includes 3.00 to 13.00 mass % of Si and 0.10 to 2.00 mass % of Mg with the balance being Al and inevitable impurities, in which

the aluminum alloy bare material for the member to be brazed is formed of an aluminum alloy including 0.004 to 6.00 mass % of Zn and 0.004 to 3.00 mass % of Mg with the balance being Al and inevitable impurities.

The present invention (2) aims to provide the aluminum alloy bare material for the member to be brazed according to (1), the aluminum alloy bare material further including 1.00 mass % or less of Bi.

The present invention (3) aims to provide the aluminum alloy bare material for the member to be brazed according to (1) or (2), the aluminum alloy bare material further including any one or more of 1.50 mass % or less of Si, 1.00 mass % or less of Fe, 1.20 mass % or less of Cu, 2.00 mass % or less of Mn, 0.30 mass % or less of Cr, 0.30 mass % or less of Ti, 0.30 mass % or less of Zr, 0.10 mass % or less of In, and 0.10 mass % or less of Sn.

The present invention (4) aims to provide the aluminum alloy bare material for the member to be brazed according to any one of (1) to (3), in which the brazing material of the brazing sheet further including any one or more of 1.00 mass % or less of Bi, 1.00 mass % or less of Fe, 1.20 mass % or less of Cu, 2.00 mass % or less of Mn, 8.00 mass % or less of Zn, 0.30 mass % or less of Cr, 0.30 mass % or less of Ti, 0.30 mass % or less of Zr, 0.10 mass % or less of In, 0.10 mass % or less of Sn, 0.05 mass % or less of Na, 0.05 mass % or less of Sr, and 0.05 mass % or less of Sb.

The present invention (5) aims to provide an aluminum alloy clad material for a member to be brazed by flux-free brazing to a brazing sheet including a brazing material formed of an aluminum alloy that includes 3.00 to 13.00 mass % of Si and 0.10 to 2.00 mass % of Mg with the balance being Al and inevitable impurities, in which

the aluminum alloy clad material for the member to be brazed includes a cladding material at an outermost layer on a brazed side, and

the cladding material is formed of an aluminum alloy including 0.004 to 8.00 mass % of Zn and 0.004 to 3.00 mass % of Mg with the balance being Al and inevitable impurities.

The present invention (6) aims to provide the aluminum alloy clad material for the member to be brazed according to (5), in which the cladding material further includes 1.00 mass % or less of Bi.

The present invention (7) aims to provide the aluminum alloy clad material for the member to be brazed according to (5) or (6), in which the cladding material further includes any one or more of 1.50 mass % or less of Si, 1.00 mass % or less of Fe, 1.20 mass % or less of Cu, 2.00 mass % or less of Mn, 0.30 mass % or less of Cr, 0.30 mass % or less of Ti, 0.30 mass % or less of Zr, 0.10 mass % or less of In, and 0.10 mass % or less of Sn.

The present invention (8) aims to provide the aluminum alloy clad material for the member to be brazed according to any one of (5) to (7), in which the brazing material of the brazing sheet further including any one or more of 1.00 mass % or less is of Bi, 1.00 mass % or less of Fe, 1.20 mass % or less of Cu, 2.00 mass % or less of Mn, 8.00 mass % or less of Zn, 0.30 mass % or less of Cr, 0.30 mass % or less of Ti, 0.30 mass % or less of Zr, 0.10 mass % or less of In, 0.10 mass % or less of Sn, 0.05 mass % or less of Na, 0.05 mass % or less of Sr, and 0.05 mass % or less of Sb.

### Advantageous Effect of Invention

According to the present invention, aluminum alloy materials for members can be provided to be well brazed to the brazing sheet with the brazing material including Mg when an aluminum material is brazed by flux-free brazing. The present invention also provides a method of producing a brazed body in which excellent brazeability is achieved by breaking the oxide film on the brazing material surface including Mg of the brazing sheet while breaking the oxide film on the member surface to be brazed when the aluminum material is brazed by flux-free brazing.

### BRIEF DESCRIPTION OF DRAWING

FIG. 1 is a side view of a test material used for the clearance filling test in Example.

### DESCRIPTION OF EMBODIMENTS

The present invention refers to an aluminum alloy bare material for a member to be brazed by flux-free brazing to a brazing sheet including a brazing material formed of an aluminum alloy that includes 3.00 to 13.00 mass % of Si and 0.10 to 2.00 mass % of Mg with the balance being Al and inevitable impurities.

This aluminum alloy bare material for the member to be brazed is formed of an aluminum alloy including 0.004 to 6.00 mass % of Zn and 0.004 to 3.00 mass % of Mg with the balance being Al and inevitable impurities.

The aluminum alloy bare material for the member to be brazed according to the present invention is not particularly limited as long as it is used as a counterpart material or a material for preparation of the counterpart material to be brazed by braze-heating to a member formed of the brazing sheet. Examples of the aluminum alloy bare material for the member to be brazed include: sheet materials to be formed into tubes, fins, headers, tanks, stacked type plates or the like; and pipe materials such as extruded pipes, extruded multi-hole pipes, and extruded tanks formed by extrusion of the aluminum alloy.

The aluminum alloy bare material for the member to be brazed according to the present invention is a material that is formed of the member formed of the brazing sheet made of aluminum alloy and a material made of aluminum alloy to be blazed by flux-free brazing, and does not include the brazing material.

The aluminum alloy bare material for the member to be brazed according to the present invention includes 0.004 to 6.00 mass % or less of Zn and 0.004 to 3.00 mass % of Mg with the balance being Al and inevitable impurities. Hereinafter, the aluminum alloy constituting the aluminum alloy bare material for the member to be brazed according to the present invention is also referred to as the aluminum alloy of the bare material for the member to be brazed.

The aluminum alloy of the bare material for the member to be brazed includes Zn. Zn degenerates an aluminum oxide film covering the surface of the member to be brazed, while exhibiting a synergistic effect with the contained Mg to assure break of the oxide film of the member to be brazed so as to improve surface wettability of the member to be brazed to the brazing material supplied from the brazing sheet. As well, Zn sets self-potential less-noble to exhibit a sacrificial corrosion protection effect. The Zn content in the aluminum alloy of the bare material for the member to be brazed is 0.004 to 6.00 mass %, preferably 0.50 to 5.00 mass %, and particularly preferably 1.50 to 3.50 mass %. The Zn content less than the above range results in an insufficient degeneration effect on the oxide film on the surface of the member to be brazed. The Zn content exceeding the above range lowers the solidus temperature (melting point) of the member to be brazed, causing melting of the member to be brazed during the brazing, and thereby easily causing erosion in the member to be brazed. Therefore, the Zn content exceeding the above range increases the amount of the brazing material of the brazing sheet diffused into the member to be brazed, decreasing the amount of the brazing material filling the clearance, and thereby resulting in poor brazeability.

The aluminum alloy of the bare material for the member to be brazed includes Mg. Mg breaks the aluminum oxide film covering the surface of the member to be brazed during the braze-heating, thereby improving the surface wettability of the member to be brazed to the brazing material supplied from the brazing sheet. The Mg content in the aluminum alloy of the bare material for the member to be brazed is 0.004 to 3.00 mass %, preferably 0.02 to 2.50 mass %, and particularly preferably 0.80 to 2.00 mass %. The Mg content less than the above range results in an insufficient destruction effect on the oxide film of the member to be brazed. The Mg content exceeding the above range causes formation of MgO on the surface of the member to be brazed, thereby resulting in poor brazeability.

The aluminum alloy of the bare material for the member to be brazed can include Bi. Bi lowers the surface tension of the member to be brazed during the braze-heating to melt the surface of the member to be brazed with the aid of the brazing material supplied from the brazing sheet, thereby improving the surface wettability of the member to be brazed to the brazing material supplied from the brazing sheet. When the aluminum alloy of the bare material for the member to be brazed includes Bi, the Bi content in the aluminum alloy of the bare material for the member to be brazed is 1.00 mass % or less, preferably 0.004 to 1.00 mass %, and particularly preferably 0.05 to 0.30 mass %. The Bi content exceeding the above range causes cracking during hot rolling, making production difficult.

The aluminum alloy of the bare material for the member to be brazed can include any one or more of 1.50 mass % or less of Si, 1.00 mass % or less of Fe, 1.20 mass % or less of Cu, 2.00 mass % or less of Mn, 0.30 mass % or less of Cr, 0.30 mass % or less of Ti, 0.30 mass % or less of Zr, 0.10 mass % or less of In, and 0.10 mass % or less of Sn.

The aluminum alloy of the bare material for the member to be brazed can include Si. Si forms intermetallic compounds together with Fe and Mn, such as Al—Mn—Si series, Al—Fe—Si series and Al—Fe—Mn-Si series, so as to contribute to dispersion reinforcement or be melted into a matrix to improve material strength through solid solution strengthening. As well, Si reacts with Mg to improve strength through age precipitation hardening of Mg₂Si compound. When the aluminum alloy of the bare material for the member to be brazed includes Si, the Si content in the aluminum alloy of the bare material for the member to be brazed is 1.50 mass % or less, preferably 0.05 to 1.50 mass %, and particularly preferably 0.20 to 1.00 mass %. The Si content exceeding the above range lowers the solidus temperature (melting point) of the member to be brazed, increasing the risk of melting of the member to be brazed during the brazing.

The aluminum alloy of the bare material for the member to be brazed can include Fe. Fe forms intermetallic compounds together with Mn and Si, such as Al—Fe—Mn series, Al—Fe—Si series and Al—Fe—Mn—Si series, contributing to dispersion reinforcement, and thereby improving material strength. When the aluminum alloy of the bare material for the member to be brazed includes Fe, the Fe content in the aluminum alloy of the bare material for the member to be brazed is 1.00 mass % or less, preferably 0.05 to 1.00 mass %, and particularly preferably 0.05 to 0.70 mass %. If Fe content exceeds the above range, giant intermetallic compounds are easily formed during the casting, leading to poor plasticity formability.

The aluminum alloy of the bare material for the member to be brazed can include Cu. Cu improves material strength through solid solution strengthening. When the aluminum alloy of the bare material for the member to be brazed includes Cu, the Cu content in the aluminum alloy of the bare material for the member to be brazed is 1.20 mass % or less, and preferably 0.05 to 0.80 mass %. The Cu content exceeding the above range lowers the solidus temperature (melting point) of the member to be brazed, increasing the risk of causing the melting of the member to be brazed during the brazing.

The aluminum alloy of the bare material for the member to be brazed can include Mn. Mn forms intermetallic compounds together with Fe and Si, such as Al-Fe—Mn series. Al-Mn-Si series and Al-Fe—Mn-Si series, so as to contribute to dispersion reinforcement or be melted into the matrix to improve material strength through solid solution strengthening. When the aluminum alloy of the bare material for the member to be brazed includes Mn, the Mn content in the aluminum alloy of the bare material for the member to be brazed is 2.00 mass % or less, and preferably 0.60 to 1.50 mass %. If Mn content exceeds the above range, giant intermetallic compounds are easily formed during the casting, leading to poor plasticity formability.

The aluminum alloy of the bare material for the member to be brazed can include any one or more of Cr, Ti and Zr. Cr, Ti and Zr improve the strength through solid solution strengthening. When the aluminum alloy of the bare material for the member to be brazed includes Cr, the Cr content in the aluminum alloy of the bare material for the member to be brazed is 0.30 mass % or less, and preferably 0.10 to 0.20 mass %. When the aluminum alloy of the bare material for the member to be brazed includes Ti, the Ti content in the aluminum alloy of the bare material for the member to be brazed is 0.30 mass % or less, and preferably 0.10 to 0.20 mass %. When the aluminum alloy of the bare material for the member to be brazed includes Zr, the Zr content in the aluminum alloy of the bare material for the member to be brazed is 0.30 mass % or less, and preferably 0.10 to 0.20 mass %. If the content of Cr, Ti or Zr exceeds the above range, giant intermetallic compounds are easily formed during the casting, leading to poor plasticity formability.

The aluminum alloy of the bare material for the member to be brazed can include either one or both of In and Sn. In and Sn can set self-potential less-noble to exhibit a sacrificial corrosion protection effect. When the aluminum alloy of the bare material for the member to be brazed includes In, the In content in the aluminum alloy of the bare material for the member to be brazed is 0.10 mass % or less, preferably 0.005 to 0.10 mass %, and particularly preferably 0.01 to 0.05 mass %. When the aluminum alloy of the bare material for the member to be brazed includes Sn, the Sn content in the aluminum alloy of the bare material for the member to be brazed is 0.10 mass % or less, preferably 0.005 to 0.10 mass %, and particularly preferably 0.01 to 0.05 mass %. The content of In or Sn exceeding the above range causes local melting during hot rolling, making production difficult.

The aluminum alloy of the bare material for the member to be brazed can include any of Ag, B, Cd, Co, Ga, Ge, Mo, Na, Ni. P, Pb, Sr, V and Hg, as the inevitable impurity(ies), at 0.05 mass % or less.

Explanations are given below regarding the brazing sheet for the aluminum alloy bare material for the member to be brazed according to the present invention, that is, the brazing sheet to be brazed to the aluminum alloy bare material for the member to be brazed according to the present invention.

The present invention refers to an aluminum alloy clad material for the member to be brazed by flux-free brazing to the brazing sheet including the brazing material formed of the aluminum alloy that includes 3.00 to 13.00 mass % of Si and 0.10 to 2.00 mass % of Mg with the balance being Al and inevitable impunities. This aluminum alloy clad material for the member to be brazed includes a cladding material at an outermost layer on a brazed side. This cladding material is formed of an aluminum alloy including 0.004 to 8.00 mass % of Zn and 0.004 to 3.00 mass % of Mg with the balance being Al and inevitable impurities.

The aluminum alloy clad material for the member to be brazed according to the present invention is not particularly limited as long as it is used as the material for preparation of the counterpart material to be brazed by braze-heating to the member formed of the brazing sheet. Examples of this aluminum alloy clad material include sheet materials to be formed into tubes, fins, headers, tanks, stacked type plates or the like.

The aluminum alloy clad material for the member to be brazed according to the present invention is the material made of aluminum alloy to be blazed by flux-free brazing to the member formed of the brazing sheet made of aluminum alloy.

The aluminum alloy clad material for the member to be brazed according to the present invention includes the cladding material (referred to as cladding material A, hereinafter) with a specific chemical composition(s) at the outermost layer on the brazed side. The aluminum alloy clad material for the member to be brazed according to the present invention has one or more clad layer(s) cladding on one side surface or both side surface of a core material. When the outermost layer on the brazed side is the cladding material A, the chemical compositions are not particularly limited for the clad layer(s) other than the core material and the cladding material A, and selected as appropriate. Examples of the aluminum alloy clad material for the member to be brazed according to the present invention include: a two-layered material formed of the core material and the cladding material A; a three-layered material formed of the cladding material A, the core material and a sacrificial anode material superimposed in this order: a three-layered material formed of the cladding material A, an intermediate layer A and the core material superimposed in this order; a three-layered material formed of the cladding material A, the core material and the cladding material A superimposed in this order; a three-layered material formed of the cladding material A, core material and the brazing material superimposed in this order; a four-layered material formed of the cladding material A, intermediate layer A, the core material and the brazing material superimposed in this order; and a four-layered material formed of the cladding material A, the core material, the intermediate layer A and the brazing material superimposed in this order. In the aluminum alloy clad material for the member to be brazed according to the present invention, examples of the clad material cladding on the core material include sacrificial anode materials, sacrificial anode materials with functions such as brazeability improvement, intermediate materials with functions such as anticorrosion is improvement and brazeability improvement, and blazing materials with functions such as brazeability with other members to be blazed.

The cladding material A in the aluminum alloy clad material for the member to be brazed according to the present invention is formed of an aluminum alloy including 0.004 to 8.00 mass % of Zn and 0.004 to 3.00 mass % of Mg with the balance being Al and inevitable impurities. Hereinafter, the aluminum alloy constituting the cladding material A in the aluminum alloy clad material for the member to be brazed according to the present invention is also referred to as the aluminum alloy of the cladding material A of the clad material for the member to be brazed.

The aluminum alloy of the cladding material A of the clad material for the member to be brazed includes Zn. Zn degenerates an aluminum oxide film covering the surface of the member to be brazed, while exhibiting a synergistic effect with the contained Mg to assure break of the oxide film of the member to be brazed so as to improve surface wettability of the member to be brazed to the brazing material supplied from the brazing sheet. As well, Zn sets self-potential less-noble to exhibit a sacrificial corrosion protection effect. The Zn content in the aluminum alloy of the cladding material A of the clad material for the member to be brazed is 0.004 to 8.00 mass %, preferably 0.50 to 5.00 mass %, and particularly preferably 1.50 to 3.50 mass %. The Zn content less than the above range results in an insufficient degeneration effect on the oxide film on the surface of the member to be brazed. The Zn content exceeding the above range lowers the solidus temperature (melting point) of the member to be brazed, increasing the risk of melting of the member to be brazed during the brazing.

The aluminum alloy of the cladding material A of the clad material for the member to be brazed includes Mg. Mg breaks the aluminum oxide film covering the surface of the member to be brazed during the braze-heating, thereby improving the surface wettability of the member to be brazed to the brazing material supplied from the brazing sheet. The Mg content in the aluminum alloy of the cladding material A of the clad material for the member to be brazed is 0.004 to 3.00 mass %, preferably 0.02 to 1.50 mass %, and particularly preferably 0.50 to 1.20 mass %. The Mg content less than the above range results in an insufficient destruction effect on the oxide film of the member to be brazed. The Mg content exceeding the above range causes formation of MgO on the surface of the member to be brazed, thereby resulting in poor brazeability.

The aluminum alloy of the cladding material A of the clad material for the member to be brazed can include Bi. Bi lowers the surface tension of the member to be brazed during the braze-heating to melt the surface of the member to be brazed with the aid of the brazing material supplied from the brazing sheet, thereby improving the surface wettability of the member to be brazed to the brazing material supplied from the brazing sheet. When the aluminum alloy of the cladding material A of the clad material for the member to be brazed includes Bi, the Bi content in the aluminum alloy of the cladding material A of the clad material for the member to be brazed is 1.00 mass % or less, preferably 0.004 to 1.00 mass %, and particularly preferably 0.05 to 0.30 mass %. The Bi content exceeding the above range causes cracking during hot rolling, making production difficult.

The aluminum alloy of the cladding material A of the clad material for the member to be brazed can include any one or more of 1.50 mass % or less of Si, 1.00 mass % or less of Fe, 1.20 mass % or less of Cu, 2.00 mass % or less of Mn, 0.30 mass % or less of Cr, 0.30 mass % or less of Ti, 0.30 mass % or less of Zr, 0.10 mass % or less of In, and 0.10 mass % or less of Sn.

The aluminum alloy of the cladding material A of the clad material for the member to be brazed can include Si. Si forms intermetallic compounds together with Fe and Mn, such as Al-Mn-Si series, Al-Fe-Si series and Al-Fe—Mn-Si series, so as to contribute to dispersion reinforcement or be melted into a matrix to improve material strength through solid solution strengthening. As well. Si reacts with Mg to improve strength through age precipitation hardening of Mg₂Si compound. When the aluminum alloy of the cladding material A of the clad material for the member to be brazed includes Si, the Si content in the aluminum alloy of the cladding material A of the clad material for the member to be brazed is 1.50 mass % or less, preferably 0.05 to 1.50 mass %, and particularly preferably 0.20 to 1.00 mass %. The Si content exceeding the above range lowers the solidus temperature (melting point) of the member to be brazed, increasing the risk of melting of the member to be brazed during the brazing.

The aluminum alloy of the cladding material A of the clad material for the member to be brazed can include Fe. Fe forms intermetallic compounds together with Mn and Si, such as Al-Fe—Mn series, Al-Fe-Si series and Al-Fe—Mn-Si series, contributing to dispersion reinforcement, and thereby improving material strength. When the aluminum alloy of the cladding material A of the clad material for the member to be brazed includes Fe, the Fe content in the aluminum alloy of the cladding material A of the clad material for the member to be brazed is 1.00 mass % or less, preferably 0.05 to 1.00 mass %, and particularly preferably 0.05 to 0.70 mass %. If Fe content exceeds the above range, giant intermetallic compounds are easily formed during the casting, leading to poor plasticity formability.

The aluminum alloy of the cladding material A of the clad material for the member to be brazed can include Cu. Cu improves material strength through solid solution strengthening. When the aluminum alloy of the cladding material A of the clad material for the member to be brazed includes Cu, the Cu content in the aluminum alloy of the cladding material A of the clad material for the member to be brazed is 1.20 mass % or less, and preferably 0.05 to 0.80 mass %. The Cu content exceeding the above range lowers the solidus temperature (melting point) of the member to be brazed, increasing the risk of causing the melting of the member to be brazed during the brazing.

The aluminum alloy of the cladding material A of the clad material for the member to be brazed can include Mn. Mn forms intermetallic compounds together with Fe and Si, such as Al-Fe—Mn series, Al-Mn-Si series and Al-Fe—Mn-Si series, so as to contribute to dispersion reinforcement or be melted into the matrix to improve material strength through solid solution strengthening. When the aluminum alloy of the cladding material A of the clad material for the member to be brazed includes Mn, the Mn content in the aluminum alloy of the cladding material A of the clad material for the member to be brazed is 2.00 mass % or less, and preferably 0.60 to 1.50 mass %. If Mn content exceeds the above range, giant intermetallic compounds are easily formed during the casting, leading to poor plasticity formability.

The aluminum alloy of the cladding material A of the clad material for the member to be brazed can include any one or more of Cr Ti and Zr. Cr, Ti and Zr improve the strength through solid solution strengthening. When the aluminum alloy of the cladding material A of the clad material for the member to be brazed includes Cr, the Cr content in the aluminum alloy of the cladding material A of the clad material for the member to be brazed is 0.30 mass % or less, and preferably 0.10 to 0.20 mass %. When the aluminum alloy of the cladding material A of the clad material for the member to be brazed includes Ti, the Ti content in the aluminum alloy of the cladding material A of the clad material for the member to be brazed is 0.30 mass % or less, and preferably 0.10 to 0.20 mass %. When the aluminum alloy of the cladding material A of the clad material for the member to be brazed includes Zr, the Zr content in the aluminum alloy of the cladding material A of the clad material for the member to be brazed is 0.30 mass % or less, and preferably 0.10 to 0.20 mass %. If the content of Cr, Ti or Zr exceeds the above range, giant intermetallic compounds are easily formed during the casting, leading to poor plasticity formability.

The aluminum alloy of the cladding material A of the clad material for the member to be brazed can include either one or both of In and Sn. In and Sn can set self-potential less-noble to exhibit a sacrificial corrosion protection effect. When the aluminum alloy of the cladding material A of the clad material for the member to be brazed includes In, the In content in the aluminum alloy of the cladding material A of the clad material for the member to be brazed is 0.10 mass % or less, preferably 0.005 to 0.10 mass %, and particularly preferably 0.01 to 0.05 mass %. When the aluminum alloy of the cladding material A of the clad material for the member to be brazed includes Sn, the Sn content in the aluminum alloy of the cladding material A of the clad material for the member to be brazed is 0.10 mass % or less, preferably 0.005 to 0.10 mass %, and particularly preferably 0.01 to 0.05 mass %. The content of In or Sn exceeding the above range causes local melting during hot rolling, making production difficult.

The aluminum alloy of the cladding material A of the clad material for the member to be brazed can include any of Ag, B, Cd, Co, Ga, Ge, Mo. Na, Ni, P, Pb, Sr, V and Hg, as the inevitable impurity(ies), at 0.05 mass % or less.

The chemical composition is selected for the clad layer other than the core material and the cladding material A in the aluminum alloy clad material for the member to be brazed according to the present invention, as appropriate depending on the application of the aluminum alloy clad material for the member to be brazed according to the present invention. Examples of the aluminum alloy constituting the core material for the aluminum alloy clad material for the member to be brazed according to the present invention include 1000 series, 3000 series, 5000 series, 6000 series and 7000 series. As the aluminum alloy constituting the intermediate layer and the sacrificial anode material relevant to the aluminum alloy clad material for the member to be brazed according to the present invention, the intermediate layer and the sacrificial anode material of the composition used for the aluminum alloy clad material for the member to be brazed can be used.

Explanations are given below regarding the brazing sheet for the aluminum alloy clad material for the member to be brazed according to the present invention, that is, the brazing sheet to be brazed to the aluminum alloy clad material for the member to be brazed according to the present invention.

The brazing sheet for the aluminum alloy bare material for the member to be brazed according to the present invention is same as the brazing sheet for the aluminum alloy clad material for the member to be brazed according to the present invention. The brazing sheet for the aluminum alloy bare material for the member to be brazed according to the present invention and the brazing sheet for the aluminum alloy clad material for the member to be brazed according to the present invention are collectively referred to as the brazing sheet according to the present invention in the following explanations.

The brazing sheet of the present invention refers to the aluminum alloy brazing sheet to be blazed by flux-free brazing to the aluminum alloy bare material for the member to be brazed according to the present invention or the aluminum alloy clad material for the member to be brazed according to the present invention.

The brazing sheet of the present invention is formed into the required shape as appropriate and then used for brazing. The brazing sheets of the present invention are formed into tubes, fins, headers, tanks or the like, for example.

The brazing sheet of the present invention includes at least the core material and the brazing material. Examples of the brazing sheet of the present invention include: a two-layered clad material formed of the core material that is provided at its one side surface with the brazing material; and a multi-layered clad material of the core material provided at its one side surface or both side surface with one or more aluminum alloy layer(s) at least one of which is(are) made of the brazing material. Examples of the multi-layered clad material include: a three-layered clad material in which the brazing material is provided on both side surfaces of the core material: a three-layered material in which the brazing material is provided on one side surface of the core material while the sacrificial anode material is provided on the other side surface of the core material; a three-layered material in which the brazing material is disposed to one side surface of the core material with the intermediate material interposed therebetween; a four-layered material in which the brazing material is disposed to one side surface of the core material with the intermediate material interposed therebetween while the sacrificial anode material is provided on the other side surface of the core material; and a five-layered clad material in which the brazing material is disposed to both side surfaces of the core material with the intermediate material interposed between the brazing material and each surface of the core material.

The core material of the brazing sheet according to the present invention refers to any of 1000-, 2000-, 3000-, 4000-, 5000-, 6000-, 7000- and 8000 series-based alloys including 3.00 mass % or less (including zero) of Mg, and preferably any of 1000-, 3000-, 5000-, 6000- and 7000 series-based alloys including 3.00 mass % or less (including zero) of Mg. The aluminum alloy constituting the core material is an existing alloy with a solidus temperature of 600° C. or more, and may be any of the 1000, 2000, 3000, 4000, 5000, 6000, 7000 and 8000 series, and preferably any of 1000, 3000, 5000, 6000 and 7000 series, and may contain 3.00 mass % or less (including zero) of Mg.

The core material of the brazing sheet according to the present invention includes Mg. Mg contained in the core material is melted into the matrix to improve material strength through solid solution strengthening. Mg contained in the core material reacts with Si to improve strength through age precipitation hardening of Mg2Si compound while being diffused into the brazing material to break the aluminum oxide film covering the surface of the brazing material during the braze-heating due to a lower free energy for the oxide formation than Al. The Mg content in the core material is 3.00 mass % or less (including zero), preferably 0.02 to 1.50 mass %, and particularly preferably 0.50 to 1.20 mass %. The Mg content in the core material exceeding the above range lowers the solidus temperature (melting point) of the core material, increasing the risk of melting of the core material during the brazing.

The core material of the brazing sheet according to the present invention can include any one or more of 1.50 mass % or less of Si, 1.00 mass % or less of Fe, 1.20 mass % or less of Cu, 2.00 mass % or less of Mn, 8.00 mass % or less of Zn, 0.30 mass % or less of Cr, 0.30 mass % or less of Ti, 0.30 mass % or less of Zr, 0.10 mass % or less of In, 0.10 mass % or less of Sn, 1.00 mass % or less of Bi, 0.05 mass % or less of Na, 0.05 mass % or less of Sr, and 0.05 mass % or less of Sb.

The core material of the brazing sheet according to the present invention can include Si. Si forms intermetallic compounds together with Fe and Mn, such as Al-Mn-Si series, Al-Fe-Si series and Al-Fe—Mn-Si series, so as to contribute to dispersion reinforcement or be melted into a matrix to improve material strength through solid solution strengthening. As well, Si reacts with Mg to improve strength through age precipitation hardening of Mg₂Si compound. When the core material of the brazing sheet according to the present invention includes Si, the Si content in the core material is 1.50 mass % or less, preferably 0.05 to 1.50 mass %, and particularly preferably 0.20 to 1.00 mass %. The Si content exceeding the above range lowers the solidus temperature (melting point) of the member to be brazed, increasing the risk of melting of the member to be brazed during the brazing.

The core material of the brazing sheet according to the present invention can include Fe. Fe forms intermetallic compounds together with Mn and Si, such as Al-Fe—Mn series, Al-Fe-Si series and Al-Fe—Mn-Si series, contributing to dispersion reinforcement, and thereby improving material strength. When the core material of the brazing sheet according to the present invention includes Fe, the Fe content in the core material is 1.00 mass 0% or less, preferably 0.05 to 1.00 mass %, and particularly preferably 0.05 to 0.70 mass %. If Fe content exceeds the above range, giant intermetallic compounds are easily formed during the casting, leading to poor plasticity formability.

The core material of the brazing sheet according to the present invention can include Cu. Cu improves material strength through solid solution strengthening. When the core material of the brazing sheet according to the present invention includes Cu, the Cu content in the core material is 1.20 mass % or less, and preferably 0.05 to 0.80 mass %. The Cu content exceeding the above range lowers the solidus temperature (melting point) of the member to be brazed, increasing the risk of causing the melting of the member to be brazed during the brazing.

The core material of the brazing sheet according to the present invention can include Mn. Mn forms intermetallic compounds together with Fe and Si, such as Al-Fe—Mn series, Al-Mn-Si series and Al-Fe—Mn-Si series, so as to contribute to dispersion reinforcement or be melted into the matrix to improve material strength through solid solution strengthening. When the core material of the brazing sheet according to the present invention includes Mn, the Mn content in the core material is 2.00 mass % or less, and preferably 0.60 to 1.50 mass %. If Mn content exceeds the above range, giant intermetallic compounds are easily formed during the casting, leading to poor plasticity formability.

The core material of the brazing sheet according to the present invention can include Zn. When the core material is not covered with the brazing material and/or the alloy layer, Zn degenerates the aluminum oxide film covering the surface of the core material, while exhibiting the synergistic effect with the contained Bi and Mg to assure destruction of the oxide film of the core material so as to improve surface wettability of the core material to the brazing material supplied from the brazing sheet. As well, Zn sets self-potential less-noble to exhibit a sacrificial corrosion protection effect. When the core material of the brazing sheet according to the present invention includes Zn, the Zn content in the core material is 8.00 mass % or less, preferably 0.50 to 5.00 mass %, and particularly preferably 1.50 to 3.50 mass %. The Zn content exceeding the above range lowers the solidus temperature (melting point) of the core material, increasing the risk of melting of the core material ding the brazing.

The core material of the brazing sheet according to the present invention can include any one or more of Cr, Ti and Zr. Cr, Ti and Zr improve the strength through solid solution strengthening. When the core material of the brazing sheet according to the present invention includes Cr, the Cr content in the core material is 0.30 mass % or less, and preferably 0.10 to 0.20 mass %. When the core material of the brazing sheet according to the present invention includes Ti, the Ti content in the core material is 0.30 mass % or less, and preferably 0.10 to 0.20 mass %. When the core material of the brazing sheet according to the present invention includes Zr, the Zr content in the core material is 0.30 mass % or less, and preferably 0.10 to 0.20 mass %. If the content of Cr, Ti or Zr exceeds the above range, giant intermetallic compounds are easily formed during the casting, leading to poor plasticity formability.

The core material of the brazing sheet according to the present invention can include either one or both of In and Sn. In and Sn can set self-potential less-noble to exhibit a sacrificial corrosion protection effect. When the core material of the brazing sheet according to the present invention includes In, the In content in the core material is 0.10 mass % or less, preferably 0.005 to 0.10 mass %, and particularly preferably 0.01 to 0.05 mass %. When the core material of the brazing sheet according to the present invention includes Sn, the Sn content in the core material is 0.10 mass % or less, preferably 0.005 to 0.10 mass %, and particularly preferably 0.01 to 0.05 mass %. The content of In or Sn exceeding the above range causes local melting during hot rolling, making production difficult.

The core material of the brazing sheet according to the present invention can include Bi. Bi lowers the surface tension of the melted brazing metal and thereby improves the brazeability during the braze-heating to melt the core material for supplying Bi to the brazing material. When the core material of the brazing sheet according to the present invention includes Sn, the Bi content in the core material is 1.00 mass % or less, and preferably 0.05 to 0.30 mass %. The Bi content exceeding the above range causes cracking during hot rolling, making production difficult.

The core material of the brazing sheet according to the present invention can include any one or more of Na, Sr and Sb. Na, Sr and Sb can be supplied to the brazing material during the braze-heating to melt the core material, enabling Si particle refinement while the brazing metal is solidified. When the core material of the brazing sheet according to the present invention includes Na, the Na content in the core material is 0.05 mass % or less, preferably 0.003 to 0.05 mass, and particularly preferably 0.005 to 0.03 mass. When the core material of the brazing sheet according to the present invention includes Sr, the Sr content in the core material is 0.05 mass % or less, preferably 0.003 to 0.05 mass, and particularly preferably 0.005 to 0.03 mass. When the core material of the brazing sheet according to the present invention includes Sb, the Sb content in the core material is 0.05 mass % or less, preferably 0.003 to 0.05 mass, and particularly preferably 0.005 to 0.03 mass.

The brazing material of the brazing sheet according to the present invention is formed of an aluminum alloy including 3.00 to 13.00 mass % of Si and 0.10 to 2.00 mass % of Mg with the balance being Al and inevitable impurities.

The Mg content in the brazing material of the brazing sheet according to the present invention is 0.10 to 2.00 mass %. The Mg content in the brazing material less than the above range results in insufficient brazeability. The Mg content in the brazing material exceeding the above range causes formation of MgO on the surface of the brazing material before the brazing metal is melted during the braze-heating, thereby resulting in poor brazeability.

The Si content in the brazing material of the brazing sheet according to the present invention is 3.00 to 13.00 mass %. The Si content in the brazing material less than the above range results in insufficient brazeability. If the Si content in the brazing material exceeds the above range, giant coarse primary crystals of Si are easily formed during the casting, easily causing cracking during the production, thereby leading to poor plasticity formability.

The brazing material of the brazing sheet according to the present invention can include any one or more of 1.00 mass % or less of Bi, 1.00 mass % or less of Fe, 1.20 mass % or less of Cu, 2.00 mass % or less of Mn, 8.00 mass % or less of Zn, 0.30 mass % or less of Cr, 0.30 mass % or less of Ti, 0.30 mass % or less of Zr, 0.10 mass % or less of In, 0.10 mass % or less of Su, 0.05 mass % or less of Na, 0.05 mass % or less of Sr, and 0.05 mass % or less of Sb.

The brazing material of the brazing sheet according to the present invention can further include Bi. Bi contained in the brazing material facilitates the breaking down of the oxide film caused by Mg that is supplied to the brazing material from the core material during the braze-heating. When the brazing material of the brazing sheet according to the present invention includes Bi, the Bi content in the brazing material is 1.00 mass % or less, and preferably 0.004 to 0.50 mass %. The Bi content in the brazing material exceeding the above range causes cracking during hot rolling, making production difficult.

The brazing material of the brazing sheet according to the present invention may include 1.00 mass % or less of Fe, and preferably 0.05 to 0.50 mass %.

The brazing material of the brazing sheet according to the present invention can include either one or both of Zn and Cu. Zn and Cu in the brazing material lower the melting point of the brazing material, enabling brazing at temperatures lower than 600° C., the typical brazing temperature. When the brazing material of the brazing sheet according to the present invention includes Zn, the Zn content in the brazing material is 8.00 mass % or less, preferably 0.50 to 8.00 mass %, and particularly preferably 2.00 to 4.00 mass %. When the brazing material of the brazing sheet according to the present invention includes Cu, the Cu content in the brazing material is 4.00 mass % or less, and preferably 1.00 to 3.00 mass %.

The brazing material of the brazing sheet according to the present invention can further include any one or more of Mn, Cr, Ti and Zr. Mn, Cr, Ti and Zr in the brazing material increase the grain size of the brazing material after the brazing, preventing the brazing material from degranulating under a corrosive environment, and thereby improving corrosion resistance. When the brazing material of the brazing sheet according to the present invention includes Mn, the Mn content in the brazing material is 2.00 mass % or less, and preferably 0.10 to 0.60 mass %. When the brazing material of the brazing sheet according to the present invention includes Cr, the Cr content in the brazing material is 0.30 mass % or less, and preferably 0.05 to 0.10 mass %. When the brazing material of the brazing sheet according to the present invention includes Ti, the Ti content in the brazing material is 0.30 mass % or less, and preferably 0.05 to 0.10 mass %. When the brazing material of the brazing sheet according to the present invention includes Zr, the Zr content in the brazing material is 0.30 mass % or less, and preferably 0.05 to 0.10 mass %. If the content of Mn, Cr, Ti or Zr in the brazing material exceeds the above range, giant intermetallic compounds are easily formed during the casting, leading to poor plasticity formability.

The brazing material of the brazing sheet according to the present invention can include either one or both of In and Sn. In and Sn in the brazing material can set self-potential of the material less-noble to exhibit a sacrificial corrosion protection effect. When the brazing material of the brazing sheet according to the present invention includes In, the In content in the brazing material is 0.10 mass % or less, preferably 0.005 to 0.10 mass %, and particularly preferably 0.01 to 0.05 mass %. When the brazing material of the brazing sheet according to the present invention includes Sn, the Sn content in the brazing material is 0.10 mass % or less, preferably 0.005 to 0.10 mass %, and particularly preferably 0.01 to 0.05 mass %.

The brazing material of the brazing sheet according to the present invention can include any one or more of Na, Sr and Sb. Na, Sr or Sb is added to the brazing material for Si particle refinement. When the brazing material of the brazing sheet according to the present invention includes Na, the Na content in the brazing material is 0.05 mass % or less, preferably 0.003 to 0.05 mass %, and particularly preferably 0.005 to 0.03 mass %. When the brazing material of the brazing sheet according to the present invention includes Sr, the Sr content in the brazing material is 0.05 mass % or less, preferably 0.003 to 0.05 mass %, and particularly preferably 0.005 to 0.03 mass %. When the brazing material of the brazing sheet according to the present invention includes Sb, the Sb content in the brazing material is 0.05 mass % or less, preferably 0.003 to 0.05 mass %, and particularly preferably 0.005 to 0.03 mass %.

The brazing material of the brazing sheet according to the present invention can include any of Ag, B, Cd, Co, Ga, Ge. Mo, Ni. P, Pb, V and Hg, as the inevitable impuity(ies), at 0.05 mass % or less.

When the aluminum alloy bare material for the member to be brazed according to the present invention or the aluminum alloy clad material for the member to be brazed according to the present invention is the sheet material for a tube material, the sheet thickness is approximately 0.15 to 0.50 mm. When the tube material is the clad material, the clad ratio of the cladding material is approximately 5 to 30%, typically. When the aluminum alloy bare material for the member to be brazed according to the present invention or the aluminum alloy clad material for the member to be brazed according to the present invention is the sheet material for plate material, the sheet thickness is approximately 0.80 to 5.0 mm. When the plate material is the clad material, the clad ratio of the cladding material is approximately 5 to 30%.

When the aluminum alloy bare material for the member to be brazed according to the present invention is an extruded pipe for coolant passage, the pipe has an outer diameter of approximately 6.0 to 20.0 mm. When the pipe is used in the clad pipe, the clad ratio of the cladding material is approximately 3 to 30%, typically. When the aluminum alloy bare material for the member to be brazed according to the present invention is the extruded multi-hole pipe for coolant passage, the multi-hole pipe has a width of approximately 10.0 to 100 mm, a thickness of approximately 1.0 to 3.0 mm, a wall thickness of approximately 0.10 to 0.30 mm, and approximately 2 to 30 holes for the multi-hole.

Explanations are given regarding a method of producing the aluminum alloy bare material for the member to be brazed according to the present invention or the aluminum alloy clad material for the member to be brazed according to the present invention. In the case of the aluminum alloy bare material for the member to be brazed according to the present invention, an aluminum alloy with a desired chemical composition to be used for the bare material is melted and casted to produce an ingot for the bare material. In the case of the aluminum alloy clad material for the member to be brazed according to the present invention, aluminum alloys with desired chemical compositions to be used for the core material and the clad layer cladding the core material are melted and casted to produce an ingot for the core material and an ingot for the clad layer. The method of melting and casting is not particularly limited but is a conventional method.

The above cast ingots are then homogenized, if necessary. The homogenization is performed for a time of 2 to 20 hours preferably at a temperature range of 400 to 630° C.

Next, the ingot for the bare material and the ingot for the core material are chamfered and then hot-rolled to achieve the predetermined thicknesses. The clad material is a laminate in which the core material and the ingot for the clad layer are superimposed in a predetermined order.

The hot working involves the hot-rolling, at 400 to 550° C., of the predetermined ingot for the bare material in the case of the bare material and the laminate formed by superimposing the ingot for the core material and the ingot for the clad layer in the predetermined order in the case of the clad material. In the hot-rolling, the rolling is continued until the sheet thickness reaches 2.0 to 8.0 mm, for example.

The cold working involves the cold-rolling the hot-rolled product obtained by the hot working. In the cold working, the cold-rolling is performed through a plurality of passes.

When intermediate annealing is performed between the passes in the cold working, the intermediate annealing is performed at a temperature of 200 to 500° C., and preferably 250 to 400° C. The intermediate annealing may involve raising a temperature up to the intermediate annealing temperature and then starting to cool immediately after the temperature reaches the intermediate annealing temperature or starting to cool after the temperature reaches the intermediate annealing temperature and then is held at the intermediate annealing temperature for a predetermined time. The time for holding at the intermediate annealing temperature is 0 to 10 hours, and preferably 1 to 5 hours.

After the cold rolling, the cold-rolled product obtained by the cold working is subjected to final annealing at 300 to 500° C., and preferably 350 to 450° C. The final annealing involves raising the temperature up to the final annealing temperature and then starting to cool immediately after the temperature reaches the final annealing temperature or starting to cool after the temperature reaches the final annealing temperature and then is held at the final annealing temperature for a predetermined time. The time for holding at the final annealing temperature is 0 to 10 hours, and preferably 1 to 5 hours. The tube material may or may not be subjected to the final annealing.

This way enables to provide the sheet-shaped aluminum alloy bare material for the member to be brazed according to the present invention or the aluminum alloy clad is material for the member to be brazed according to the present invention.

For the sheet-shaped aluminum alloy bare material for the member to be brazed according to the present invention or the aluminum alloy clad material for the member to be brazed according to the present invention, the brazeability can be further improved by etching the aluminum alloy bare material for the member to be brazed according to the present invention or the aluminum alloy clad material for the member to be brazed according to the present invention before the blazing. An aqueous solution containing any one or more of sulfuric acid, hydrochloric acid, nitric acid, phosphoric acid and hydrofluoric acid, for example, can be used as an acid. The preferred etching amount range is 0.05 to 2.0 g/m².

When the aluminum alloy bare material for the member to be brazed according to the present invention is an extruded pipe material, the melted aluminum alloy is casted into ingot by a conventional method to provide a billet with a predetermined composition. Next, the billet obtained is treated for homogenization, then reheated for the extrusion, and then subjected to port-hole extrusion so that the extruded pipe has a predetermined wall thickness to produce an extruded pipe material. The homogenization is performed for a time of 2 to 20 hours preferably at a temperature range of 400 to 630° C. The extrusion is performed preferably within a temperature range of 400 to 550° C. The preferred extrusion ratio is 10 to 200. The preferred range of the wall thickness of the tube obtained after the extrusion is 0.5 to 10.0 mm.

The extruded pipe material is further subjected to drawing and annealing as required, and further subjected to drawing and final annealing as required. The annealing is performed for a time of 0 to 10 hours preferably within a temperature range of 300 to 500° C. The preferred range of final wall thickness of the tube used for the drawing is 0.1 to 3 mm.

For the extruded pipe material, the brazeability can be further improved by etching the extruded pipe prior to the brazing. An aqueous solution containing any one or more of sulfinic acid, hydrochloric acid, nitric acid, phosphoric acid and hydrofluoric acid, for example, can be used as an acid. The preferred etching amount range is 0.05 to 2.0 g/m².

When the aluminum alloy bare material for the member to be brazed according to the present invention is the extruded multi-hole pipe material, the melted aluminum alloy is casted into ingot by the conventional method to provide a billet with a predetermined composition. Next, the billet obtained is treated for homogenization, then reheated for the extrusion, and then subjected to port-hole extrusion so that the extruded pipe has a predetermined wall thickness to produce extruded multi-hole pipe material. The homogenization is performed for a time of 2 to 20 hours preferably at a temperature range of 400 to 630° C. The extrusion is performed preferably within a temperature range of 400 to 550° C. The preferred extrusion ratio is 50 to 2,500.

The material is further subjected to the final annealing as required. The final annealing is performed preferably within a temperature range of 300 to 500° C. for a time of 0 to 50 hours. The extruded multi-hole pipe produced may be sized to improve an outer dimension accuracy. In this case, the preferred range for the degree of processing is 0.5 to 10%.

For the extruded multi-hole pipe material, the brazeability can be further improved by etching the extruded pipe prior to the brazing. An aqueous solution containing any one or more of sulfuric acid, hydrochloric acid, nitric acid, phosphoric acid and hydrofluoric acid, for example, can be used as an acid. The preferred etching amount range is 0.05 to 2.0 g/m².

For example, the brazing can be performed by flux-free braze-heating, after preparation of an assembled product by assembling a formed product of the brazing sheet according to the present invention with either one of formed products of the aluminum alloy bare material for the member to be brazed according to the present invention and the aluminum alloy clad material for the member to be brazed according to the present invention.

In addition to the formed product of the brazing sheet according to the present invention and either one of the formed products of the aluminum alloy bare material for the member to be brazed according to the present invention and the aluminum alloy clad material for the member to be brazed according to the present invention, another member can be assembled as required to produce the assembled product.

The braze-heating can be performed at a braze-heating temperature of 580 to 620° C., for example, and preferably 590 to 610° C., for a braze-heating time of 10 to 60 minutes, for example, and preferably 15 to 40 minutes, under an inert gas atmosphere such as nitrogen gas atmosphere as brazing atmosphere.

Examples are given below to illustrate the present invention in detail, but the present invention is not limited to the Examples shown below.

### EXAMPLES

For a brazing sheet for a plate material, a continuous casting was employed to produce ingots for a brazing material(s), a core material(s) and a cladding material(s) with chemical compositions listed in Table 1. Then, the ingot for the core material was homogenized and face-milled to a predetermined thickness. Some of the ingots for the brazing material and the cladding material were face-milled without being homogenized. Next, hot rolling was performed on the ingots for the brazing material and the cladding material to achieve sheet thicknesses to predetermined thicknesses for the ingots for the brazing material and the cladding material. The ingots obtained for the brazing material, the cladding material and the core material were superimposed according to combinations listed in Table 1 to produce a laminate. The laminate obtained was hot-rolled to joint the ingots for the brazing material, the cladding material and the core material and then produce a hot-rolled product with a sheet thickness of 3.0 mm. The hot-rolled product obtained was subjected to cold-rolling and final annealing in sequence to produce a clad material (test material) with a sheet thickness of 0.8 mm. However, only test material No. B03 was a clad material (test material) with a thickness of 1.0 mm. The final annealing was continued at a holding temperature of 400° C. for a holding time of 3 hours.

For a bare material to be used for a member to be brazed, alloys listed in Table 2 were used. Some of the alloys were homogenized and then face-milled to a predetermined thickness. Next, hot rolling is performed to produce a hot-rolled material with a thickness of 3.0 mm. The hot-rolled material was then cold rolled, intermediate annealed, and cold rolled in sequence to obtain a bare material (test material) with a thickness of 1.0 mm. The intermediate annealing was performed at the holding temperature of 400° C. for the holding time of 3 hours.

<Evaluation of Brazeability>

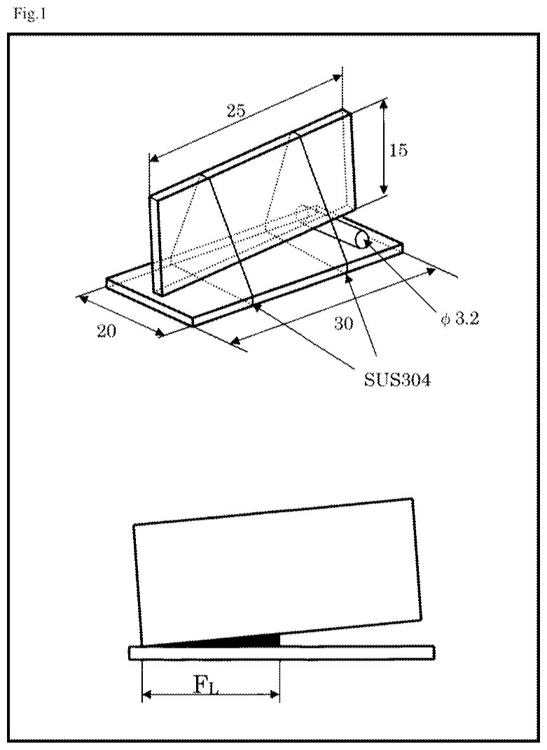

The brazeability was evaluated for each test material by performing a clearance filling test. As illustrated in FIG. 1, the test materials used in the clearance filling test was prepared by disposing the brazing sheet as a vertically oriented sheet and the member to be blazed as a horizontally oriented sheet that were fastened to each other with SUS wires, and then brazed in a furnace under a nitrogen gas atmosphere. In the furnace, the atmosphere was set to an oxygen concentration of less than 10 volumetric ppm while the maximum temperature of the test material was set to 600° C. Some of the test materials used were pickled before fastened with the SUS wires.

In the clearance filling test, the brazeability was evaluated based on length FL of a fillet formed after the brazing. The “clearance filling test” column of Table 3 is marked “⊚” if the FL is 14.0 mm or more, “∘” if the FL is 12.0 mm or more, and “x” if the FL is less than 12.0 mm. Note that “⊚” means “very good brazeability and acceptable”, “∘” means “excellent brazeability and acceptable”, and “x” means “inferior brazeability and unacceptable”.

TABLE 1

| | Test | Clad | Chemical composition (mass %) | | | | | | | | | Thickness | |
|---|---|---|---|---|---|---|---|---|---|---|---|---|---|
| | material No | composition | Si | Fe | Cu | Mn | Mg | Zn | Ti | Bi | Sr | (μm) | Homogenization |
| Example | B01 | Brazing material | 11.80 | 0.30 | — | 0.01 | 0.60 | 0.01 | 0.01 | 0.30 | — | 64 | No |
| | | Core material | 0.25 | 0.12 | 0.12 | 1.20 | 0.60 | — | 0.11 | — | — | — | 500° C. |
| | | Cladding material | 0.10 | 0.30 | — | — | — | 1.40 | 0.01 | — | — | 80 | No |
| | B02 | Brazing material | 11.76 | 0.31 | — | — | 0.58 | — | — | 0.28 | — | 50 | No |
| | | Core material | 0.25 | 0.12 | 0.12 | 1.15 | 0.59 | — | 0.11 | — | — | — | 500° C. |
| | | Brazing material | 11.76 | 0.31 | — | — | 0.58 | — | — | 0.28 | — | 50 | No |
| | B03 | Brazing material | 11.70 | 0.25 | — | — | 1.00 | — | 0.07 | 0.31 | — | 50 | No |
| | | Core material | 0.24 | 0.13 | 0.14 | 1.19 | 0.59 | — | 0.12 | — | — | — | 500° C. |
| | | Brazing material | 11.70 | 0.25 | — | — | 1.00 | — | 0.07 | 0.31 | — | 50 | No |

TABLE 2

| | Test | Clad | Chemical composition (mass %) | | | | | | | | | | |
|---|---|---|---|---|---|---|---|---|---|---|---|---|---|
| | material No | composition | Si | Fe | Cu | Mn | Mg | Zn | Ti | Bi | Sn | In | Homogenization |
| Example | F131 | Bare | 0.15 | 0.35 | — | — | 0.10 | 2.90 | — | 0.10 | — | — | No |
| | F132 | Bare | 0.15 | 0.35 | — | — | 0.10 | 2.90 | — | 0.10 | — | — | 500° C. |
| | F134 | Bare | 0.15 | 0.35 | — | — | 0.60 | 2.90 | — | 0.20 | — | — | No |
| | F142 | Bare | 0.05 | 0.10 | — | 0.30 | 0.010 | 0.010 | — | — | — | — | No |
| | F143 | Bare | 0.05 | 0.10 | — | 0.60 | 0.010 | 0.010 | — | — | — | — | No |
| | F144 | Bare | 0.05 | 0.10 | — | — | 0.10 | 0.010 | — | — | — | — | No |
| | F145 | Bare | 0.05 | 0.10 | — | — | 0.20 | 0.010 | — | — | — | — | No |
| | F146 | Bare | 0.05 | 0.10 | — | — | 0.40 | 0.010 | — | — | — | — | No |
| | F147 | Bare | 0.05 | 0.10 | — | — | 0.80 | 0.010 | — | — | — | — | No |
| | F148 | Bare | 0.05 | 0.10 | — | — | 1.60 | 0.010 | — | — | — | — | No |
| | F149 | Bare | 0.05 | 0.10 | — | — | 0.010 | 0.30 | — | — | — | — | No |
| | F150 | Bare | 0.05 | 0.10 | — | — | 0.010 | 0.60 | — | — | — | — | No |
| | F151 | Bare | 0.05 | 0.10 | — | — | 0.010 | 1.50 | — | — | — | — | No |
| | F153 | Bare | 0.05 | 0.10 | — | — | 0.010 | 5.50 | — | — | — | — | No |
| | F160 | Bare | 0.05 | 0.10 | — | — | 0.010 | 0.010 | — | — | 0.05 | — | No |
| | F162 | Bare | 0.05 | 0.10 | — | — | 0.010 | 0.010 | — | — | — | 0.05 | No |
| | F163 | Bare | 0.05 | 0.10 | — | — | 0.010 | 0.010 | — | — | — | 0.10 | No |
| | F165 | Bare | 0.05 | 0.10 | — | — | 0.20 | 1.50 | — | — | — | — | No |
| | F166 | Bare | 0.05 | 0.10 | — | — | 0.40 | 1.50 | — | — | — | — | No |
| | F167 | Bare | 0.05 | 0.10 | — | — | 0.80 | 1.50 | — | — | — | — | No |
| | F156 | Bare | 0.20 | 0.10 | — | — | 0.010 | 0.010 | — | — | — | — | No |
| | F157 | Bare | 0.40 | 0.10 | — | — | 0.010 | 0.010 | — | — | — | — | No |
| | F158 | Bare | 1.00 | 0.10 | — | — | 0.010 | 0.010 | — | — | — | — | No |
| | F160 | Bare | 0.05 | 0.10 | 0.20 | — | 0.010 | 0.010 | — | — | — | — | No |
| | F161 | Bare | 0.05 | 0.10 | 0.40 | — | 0.010 | 0.010 | — | — | — | — | No |
| | F162 | Bare | 0.05 | 0.10 | 1.00 | — | 0.010 | 0.010 | — | — | — | — | No |
| | F163 | Bare | 0.05 | 0.10 | — | — | 0.010 | 4.50 | — | — | — | — | No |
| | F164 | Bare | 0.20 | 0.10 | — | — | 0.20 | 0.010 | — | — | — | — | No |
| | F165 | Bare | 0.40 | 0.10 | — | — | 0.20 | 0.010 | — | — | — | — | No |
| | F166 | Bare | 0.20 | 0.10 | — | — | 0.40 | 0.010 | — | — | — | — | No |
| | F167 | Bare | 0.40 | 0.10 | — | — | 0.40 | 0.010 | — | — | — | — | No |
| | F168 | Bare | 0.20 | 0.10 | — | — | 0.010 | 4.50 | — | — | — | — | No |
| | F169 | Bare | 0.40 | 0.10 | — | — | 0.010 | 4.50 | — | — | — | — | No |
| Comparative | F127 | Bare | 0.15 | 0.35 | — | — | — | 2.90 | — | — | — | — | No |
| Example | F133 | Bare | 0.15 | 0.35 | — | — | — | 2.90 | — | 0.20 | — | — | No |
| | F138 | Bare | 0.15 | 0.35 | — | — | 1.60 | — | — | — | — | — | No |
| | F141 | Bare | 0.05 | 0.10 | — | — | — | — | — | — | — | — | No |
| | F154 | Bare | 0.05 | 0.10 | — | — | 0.010 | 8.00 | — | — | — | — | No |

TABLE 3

| | | Brazing | Member to | | |
|---|---|---|---|---|---|
| | | sheet | be blazed | | Clearance |
| | Test | Vertically | Horizontally | | filling |
| | material | oriented | oriented | Acid | test |
| | No | plate | plate | cleaning | Judgement |
| Example | 1 | B01 | F131 | Yes | ⊚ |
| | 2 | B01 | F132 | Yes | ⊚ |
| | 3 | B01 | F134 | Yes | ⊚ |
| | 4 | B02 | F142 | Yes | ◯ |
| | 5 | B02 | F143 | Yes | ◯ |
| | 6 | B02 | F144 | Yes | ⊚ |
| | 7 | B02 | F145 | Yes | ⊚ |
| | 8 | B02 | F146 | Yes | ⊚ |
| | 9 | B02 | F147 | Yes | ⊚ |
| | 10 | B02 | F148 | Yes | ⊚ |
| | 11 | B02 | F149 | Yes | ⊚ |
| | 12 | B02 | F150 | Yes | ◯ |
| | 13 | B02 | F151 | Yes | ⊚ |
| | 14 | B02 | F153 | Yes | ◯ |
| | 15 | B02 | F160 | Yes | ⊚ |
| | 16 | B02 | F162 | Yes | ⊚ |
| | 17 | B02 | F163 | Yes | ⊚ |
| | 18 | B02 | F165 | Yes | ⊚ |
| | 19 | B02 | F166 | Yes | ⊚ |
| | 20 | B02 | F167 | Yes | ⊚ |
| | 21 | B03 | F156 | Yes | ⊚ |
| | 22 | B03 | F157 | Yes | ⊚ |
| | 23 | B03 | F158 | Yes | ⊚ |
| | 24 | B03 | F160 | Yes | ⊚ |
| | 25 | B03 | F161 | Yes | ⊚ |
| | 26 | B03 | F162 | Yes | ⊚ |
| | 27 | B03 | F163 | Yes | ⊚ |
| | 28 | B03 | F164 | Yes | ⊚ |
| | 29 | B03 | F165 | Yes | ⊚ |
| | 30 | B03 | F166 | Yes | ⊚ |
| | 31 | B03 | F167 | Yes | ⊚ |
| | 32 | B03 | F168 | Yes | ⊚ |
| | 33 | B03 | F169 | Yes | ⊚ |
| Comparative | R101 | B01 | F127 | Yes | X |
| Example | R103 | B01 | F133 | Yes | X |
| | R104 | B02 | F138 | No | X |
| | R105 | B02 | F141 | Yes | X |
| | R106 | B02 | F151 | Yes | X |

As listed in Table 3, the test materials, which are examples of the present invention, were confirmed to have excellent joint conditions at acceptable levels.

1. An aluminum alloy bare material for a member to be brazed by flux-free brazing to a brazing sheet comprising a brazing material formed of an aluminum alloy that comprises 3.00 to 13.00 mass % of Si and 0.10 to 2.00 mass % of Mg with the balance being Al and inevitable impurities, wherein
the aluminum alloy bare material for the member to be brazed is formed of an aluminum alloy comprising 0.004 to 6.00 mass % of Zn and 0.004 to 3.00 mass % of Mg with the balance being Al and inevitable impurities.

2. The aluminum alloy bare material for the member to be brazed according to claim 1, the aluminum alloy bare material for the member to be brazed further comprising 1.00 mass % or less of Bi.

3. The aluminum alloy bare material for the member to be brazed according to claim 1, the aluminum alloy bare material for the member to be brazed further comprising any one or more of 1.50 mass % or less of Si, 1.00 mass % or less of Fe, 1.20 mass % or less of Cu, 2.00 mass % or less of Mn, 0.30 mass % or less of Cr, 0.30 mass % or less of Ti, 0.30 mass % or less of Zr, 0.10 mass % or less of In, and 0.10 mass % or less of Sn.

4. The aluminum alloy bare material for the member to be brazed according to claim 1, wherein the brazing material of the brazing sheet further comprises any one or more of 1.00 mass % or less of Bi, 1.00 mass % or less of Fe, 1.20 mass % or less of Cu, 2.00 mass % or less of Mn, 8.00 mass % or less of Zn, 0.30 mass % or less of Cr, 0.30 mass % or less of Ti, 0.30 mass % or less of Zr, 0.10 mass % or less of In, 0.10 mass % or less of Sn, 0.05 mass % or less of Na, 0.05 mass % or less of Sr, and 0.05 mass % or less of Sb.

5. An aluminum alloy clad material for a member to be brazed by flux-free brazing to a brazing sheet comprising a brazing material formed of an aluminum alloy that comprises 3.00 to 13.00 mass % of Si and 0.10 to 2.00 mass % of Mg with the balance being Al and inevitable impurities, wherein
the aluminum alloy clad material for the member to be brazed comprises a cladding material at an outermost layer on a brazed side, and
the cladding material is formed of an aluminum alloy comprising 0.004 to 8.00 mass % of Zn and 0.004 to 3.00 mass % of Mg with the balance being Al and inevitable impurities.

6. The aluminum alloy clad material for the member to be brazed according to claim 5, wherein the cladding material further comprises 1.00 mass % or less of Bi.

7. The aluminum alloy clad material for the member to be brazed according to claim 5, wherein the cladding material further comprises any one or more of 1.50 mass % or less of Si, 1.00 mass % or less of Fe, 1.20 mass % or less of Cu, 2.00 mass % or less of Mn, 0.30 mass % or less of Cr, 0.30 mass % or less of Ti, 0.30 mass % or less of Zr, 0.10 mass % or less of In, and 0.10 mass % or less of Sn.

8. The aluminum alloy clad material for the member to be brazed according to claim 5, wherein the brazing material of the brazing sheet further comprises any one or more of 1.00 mass % or less of Bi, 1.00 mass % or less of Fe, 1.20 mass % or less of Cu, 2.00 mass % or less of Mn, 8.00 mass % or less of Zn, 0.30 mass % or less of Cr, 0.30 mass % or less of Ti, 0.30 mass % or less of Zr, 0.10 mass % or less of In, 0.10 mass % or less of Sn, 0.05 mass % or less of Na, 0.05 mass % or less of Sr, and 0.05 mass % or less of Sb.

9. The aluminum alloy bare material for the member to be brazed according to claim 2, the aluminum alloy bare material for the member to be brazed further comprising any one or more of 1.50 mass % or less of Si, 1.00 mass % or less of Fe, 1.20 mass % or less of Cu, 2.00 mass % or less of Mn, 0.30 mass % or less of Cr, 0.30 mass % or less of Ti, 0.30 mass % or less of Zr, 0.10 mass % or less of In, and 0.10 mass % or less of Sn.

10. The aluminum alloy bare material for the member to be brazed according to claim 2, wherein the brazing material of the brazing sheet further comprises any one or more of 1.00 mass % or less of Bi, 1.00 mass % or less of Fe, 1.20 mass % or less of Cu, 2.00 mass % or less of Mn, 8.00 mass % or less of Zn, 0.30 mass % or less of Cr, 0.30 mass % or less of Ti, 0.30 mass % or less of Zr, 0.10 mass % or less of In, 0.10 mass % or less of Sn, 0.05 mass % or less of Na, 0.05 mass % or less of Sr, and 0.05 mass % or less of Sb.

11. The aluminum alloy bare material for the member to be brazed according to claim 3, wherein the brazing material of the brazing sheet further comprises any one or more of 1.00 mass % or less of Bi, 1.00 mass % or less of Fe, 1.20 mass % or less of Cu, 2.00 mass % or less of Mn, 8.00 mass % or less of Zn, 0.30 mass % or less of Cr, 0.30 mass % or less of Ti, 0.30 mass % or less of Zr, 0.10 mass % or less of In, 0.10 mass % or less of Sn, 0.05 mass % or less of Na, 0.05 mass % or less of Sr, and 0.05 mass % or less of Sb.

12. The aluminum alloy clad material for the member to be brazed according to claim 6, wherein the cladding material further comprises any one or more of 1.50 mass % or less of Si, 1.00 mass % or less of Fe, 1.20 mass % or less of Cu, 2.00 mass % or less of Mn, 0.30 mass % or less of Cr, 0.30 mass % or less of Ti, 0.30 mass % or less of Zr, 0.10 mass % or less of In, and 0.10 mass % or less of Sn.

13. The aluminum alloy clad material for the member to be brazed according to claim 6, wherein the brazing material of the brazing sheet further comprises any one or more of 1.00 mass % or less of Bi, 1.00 mass % or less of Fe, 1.20 mass % or less of Cu, 2.00 mass % or less of Mn, 8.00 mass % or less of Zn, 0.30 mass % or less of Cr, 0.30 mass % or less of Ti, 0.30 mass % or less of Zr, 0.10 mass % or less of In, 0.10 mass % or less of Sn, 0.05 mass % or less of Na, 0.05 mass % or less of Sr, and 0.05 mass % or less of Sb.

14. The aluminum alloy clad material for the member to be brazed according to claim 7, wherein the brazing material of the brazing sheet further comprises any one or more of 1.00 mass % or less of Bi, 1.00 mass % or less of Fe, 1.20 mass % or less of Cu, 2.00 mass % or less of Mn, 8.00 mass % or less of Zn, 0.30 mass % or less of Cr, 0.30 mass % or less of Ti, 0.30 mass % or less of Zr, 0.10 mass % or less of In, 0.10 mass % or less of Sn, 0.05 mass % or less of Na, 0.05 mass % or less of Sr, and 0.05 mass % or less of Sb.
